(19) United States
(12) Patent Application Publication
(10) Pub. No.: US 2025/0378267 A1
(43) Pub. Date: Dec. 11, 2025

(54) COMPUTER-AUTOMATED SYSTEMS AND METHODS FOR DETECTING SOURCE CODE PLAGIARISM

(71) Applicant: StartOS Inc., New Providence, NJ (US)

(72) Inventor: Jason Nichols, New Providence, NJ (US)

(73) Assignee: StartOS Inc., New Providence, NJ (US)

(21) Appl. No.: 18/796,507

(22) Filed: Aug. 7, 2024

Related U.S. Application Data
(63) Continuation-in-part of application No. 18/791,723, filed on Aug. 1, 2024.
(60) Provisional application No. 63/657,325, filed on Jun. 7, 2024.
(60) Provisional application No. 63/657,362, filed on Jun. 7, 2024.

(51) Int. Cl. G06F 40/194; G06F 40/289; G06F 40/30

(52) U.S. Cl. CPC G06F 40/194; G06F 40/289; G06F 40/30

(57) ABSTRACT

One embodiment of the present invention relates to a computer-automated system and method for identifying copyrighted source code embedded within other source code files, utilizing advanced semantic analysis techniques. This embodiment of the invention addresses the challenge of detecting both literal and non-literal copies of copyrighted code, including instances where the code has been modified in non-semantic ways, such as through renaming variables, changing formatting, or rearranging code blocks. This embodiment creates semantic embeddings of source code using a large language model (LLM). Each segment of source code is transformed into a high-dimensional vector that captures its semantic essence, rather than its literal text. These vectors are then compared using sophisticated similarity metrics, such as cosine similarity or L2 distance, to determine the likelihood of copyright infringement. This embodiment can operate without direct access to the full source code, thereby enhancing privacy and security. Instead, the system works with embeddings that represent the semantic information of the code, significantly reducing the risk of data exposure. Additionally, this embodiment of the invention includes an optional compression module that further minimizes the data footprint by compressing the semantic vectors, enhancing the system's efficiency and scalability. This embodiment of the invention is particularly suited for use in environments where large volumes of code need to be analyzed quickly and accurately, such as in continuous integration/continuous deployment (CI/CD) pipelines. It provides a robust, scalable, and secure solution for managing copyright compliance in software development, offering significant improvements over traditional text-based or hash-based comparison methods.

### CROSS-REFERENCE TO RELATED APPLICATIONS

This application claims priority to U.S. Prov. Pat. App. No. 63/657,325, filed on Jun. 7, 2024, entitled, “Computer-Automated Systems and Methods for Calculating Software Development Metrics for Use in Diligence,” which is hereby incorporated by reference herein.

This application claims priority to U.S. Prov. Pat. App. No. 63/657,362, filed on Jun. 7, 2024, entitled, “Computer-Automated Systems and Methods for Detecting Source Code Plagiarism,” which is hereby incorporated by reference herein.

This application is a continuation-in-part of U.S. patent application Ser. No. 18/791,723, filed on Aug. 1, 2024, entitled, “Computer-Automated Systems and Methods for Generating Software Development Metrics for Use in Diligence,” which is hereby incorporated by reference herein.

### BACKGROUND

In the realm of software development, the reuse and incorporation of existing source code into new projects is a common practice. This approach can significantly accelerate development processes and enhance functionality. However, it also introduces substantial risks, particularly concerning the inadvertent or intentional inclusion of copyrighted material without proper authorization. The legal and financial repercussions of such copyright infringements can be severe for individuals and organizations alike.

Traditional methods for detecting copyrighted content in source code primarily rely on direct text comparison techniques or hash-based comparisons. These methods can effectively identify exact copies or near-exact copies of text or code segments. However, they fall short in several critical areas. For example, conventional methods struggle to detect instances where the code has been altered in non-semantic ways. Simple modifications such as renaming variables, altering formatting, or rearranging code blocks can easily evade detection, despite the underlying logic and functionality remaining unchanged. Most existing tools also lack the capability to understand the semantics of the code. They cannot assess whether different segments of code perform similar functions or achieve similar outcomes, which is a critical aspect when evaluating the originality of a codebase. Furthermore, the process of comparing large codebases using traditional methods can be computationally intensive and time-consuming. As the size of the databases and the complexity of the code increase, these methods become less practical, often requiring substantial computational resources and processing time. In addition, current approaches require access to the complete source code for both the target and the reference databases. This necessity poses significant privacy and security risks, as exposing source code to external systems or third parties can lead to leaks and other security vulnerabilities.

These limitations highlight the need for a more advanced, efficient, and secure method to identify and manage copyrighted material in software development projects. A solution that addresses these challenges would not only enhance legal compliance and reduce liability but also support the ethical use of intellectual property in the software development community.

### SUMMARY

One embodiment of the present invention relates to a computer-automated system and method for identifying copyrighted source code embedded within other source code files, utilizing advanced semantic analysis techniques. This embodiment of the invention addresses the challenge of detecting both literal and non-literal copies of copyrighted code, including instances where the code has been modified in non-semantic ways, such as through renaming variables, changing formatting, or rearranging code blocks. This embodiment creates semantic embeddings of source code using a large language model (LLM). Each segment of source code is transformed into a high-dimensional vector that captures its semantic essence, rather than its literal text. These vectors are then compared using sophisticated similarity metrics, such as cosine similarity or L2 distance, to determine the likelihood of copyright infringement. This embodiment can operate without direct access to the full source code, thereby enhancing privacy and security. Instead, the system works with embeddings that represent the semantic information of the code, significantly reducing the risk of data exposure. Additionally, this embodiment of the invention includes an optional compression module that further minimizes the data footprint by compressing the semantic vectors, enhancing the system's efficiency and scalability. This embodiment of the invention is particularly suited for use in environments where large volumes of code need to be analyzed quickly and accurately, such as in continuous integration/continuous deployment (CI/CD) pipelines. It provides a robust, scalable, and secure solution for managing copyright compliance in software development, offering significant improvements over traditional text-based or hash-based comparison methods.

Other features and advantages of various aspects and embodiments of the present invention will become apparent from the following description and from the claims.

### BRIEF DESCRIPTION OF THE DRAWINGS

FIG. 1 is a dataflow diagram of a system for ingesting source data according to one embodiment of the present invention.

FIG. 2 is a flowchart of a method performed by the system of FIG. 1 according to one embodiment of the present invention.

FIG. 3 is a dataflow diagram of a system for analyzing source code to detect copyrighted code within that source code according to one embodiment of the present invention.

FIG. 4 is a flowchart of a method performed by the system of FIG. 3 according to one embodiment of the present invention.

### DETAILED DESCRIPTION

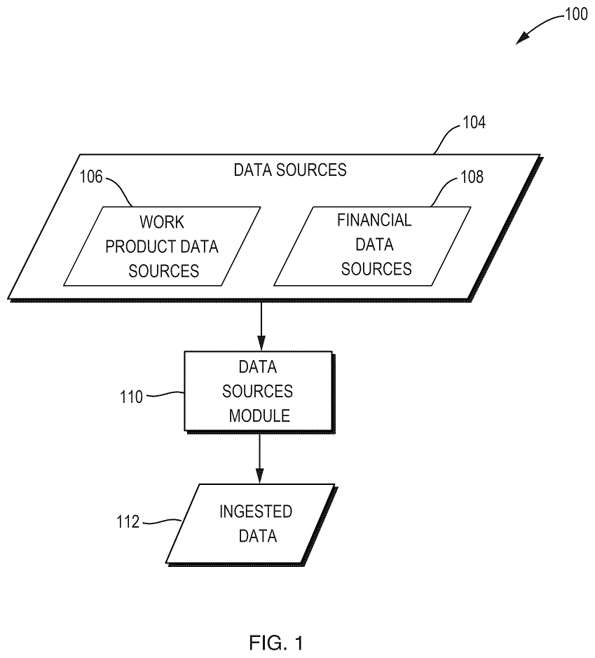

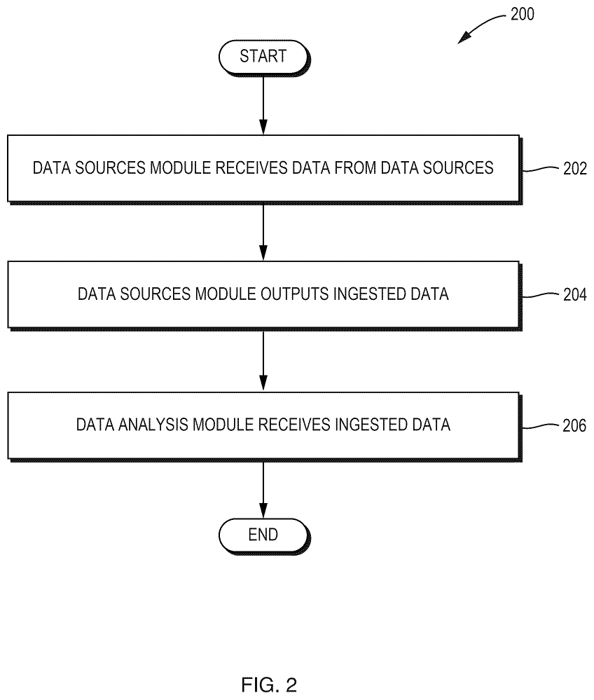

Referring to FIG. 1, a dataflow diagram is shown of a system 100 for ingesting source data according to one embodiment of the present invention. Referring to FIG. 2, a flowchart is shown of a method 200 performed by the system 100 according to one embodiment of the present invention.

The system 100 includes a plurality of data sources 104. The plurality of data sources 104 may, for example, include a work product data source 106 and a financial data source 108. The work product data source 106 may include any of a variety of data generated by and/or associated with one or a plurality of workers. As an example, the work product data source 106 may include source code written, generated by, and/or otherwise associated with one or a plurality of software developers. As will be described in more detail below, the work product data source 106 may include metadata which may associate work product (e.g., source code) within the work product data source 106 with one or more corresponding workers (e.g., the worker(s) who created (e.g., wrote) that work product). Although the work product data source 106 is referred to herein as a data “source,” in practice the work product data source 106 may include one or a plurality of data sources.

The work product data source 106, which includes source code, can be implemented using various data sources at different levels of abstraction. These data sources range from high-level platforms to more detailed, specific tools that manage and store source code. Below are examples at high, medium, and low levels of abstraction, including popular commercial platforms that could be used to implement the work product data source 106.

At a high level, the work product data source 106 may be any system that stores and/or serves outputs (e.g., digital data) created by one or more workers. In the context of workers who are software developers, this may include, for example:
Integrated Development Environments (IDEs): While primarily used for coding, IDEs often have local history features that can serve as a source of work product data.
Cloud-Based Development Platforms: Platforms like AWS Cloud9 or Microsoft Visual Studio Online, which not only provide coding environments but also store versions of the code being developed.

More specifically, the work product data source 106 may include one or more systems designed for version control and/or collaborative coding, which are used for tracking changes and contributions by individual developers. Examples of these include:
Version Control Systems (VCS): These are tools specifically designed to manage changes to documents, programs, and other information stored as files.
Git: A distributed version control system that handles everything from small to very large projects with speed and efficiency.
Subversion (SVN): A centralized version control system that records changes to files and directories over time.

Even more specifically, the work product data source 106 may, for example, be implemented using specific instances or deployments of version control systems, configured for particular organizational needs. Examples of these include GitHub, GitLab, and Bitbucket.

The work product data source 106 may include any of a variety of data types that are relevant to assessing the productivity and contributions of software developers. An example is the inclusion of data from ticketing systems, such as those which are commonly used in customer support and project management contexts. The work product data source 106 may include data from customer support ticketing systems and/project management ticketing systems. Data from customer support ticketing systems can provide insights into how software developers interact with end-users, manage and resolve issues, and contribute to customer satisfaction and product improvement. This data may include records of bug reports, feature requests, user feedback, and the developers' responses and resolutions. Including this data allows the system 100 to assess the impact of developers on customer relations and product reliability, which are crucial metrics for evaluating developer effectiveness and the quality of the software.

Data from project management ticketing systems typically includes information on task assignments, progress updates, completion statuses, and time logs related to specific development projects or tasks. This data helps in tracking the contributions of individual developers to various projects, their efficiency in handling tasks, and their ability to meet deadlines and project goals. By analyzing this data, the system 100 can generate detailed insights into the productivity, work habits, and project impact of software developers, facilitating a comprehensive evaluation of their performance.

Incorporating data from ticketing systems into the work product data source 106 provides several advantages, such as enabling a more holistic assessment of a developer's role and effectiveness across different aspects of software development, from coding to customer interaction and project management. Incorporating ticketing system data also offers enhanced visibility into the day-to-day operations and challenges faced by developers, providing context that can be crucial for understanding productivity metrics and developmental outcomes. Furthermore, the integration of diverse data sources like ticketing systems facilitates richer, data-driven insights into developer performance, supporting better-informed decision-making processes regarding promotions, training needs, and project assignments.

The financial data source 108 may include any of a variety of financial data associated with one or a plurality of workers, such as the workers who are associated with the work product data source 106. The financial data source 108. As will be described in more detail below, the system 100 may use the data in the financial data source 108 to calculate and assess the financial productivity and efficiency of the workers, particularly in relation to the value of the work products they generate. Although the financial data source 108 is referred to herein as a data “source,” in practice the financial data source 108 may include one or a plurality of data sources.

The financial data source 108 may, for example, include payroll data which details the compensation paid to the workers who created the data in the work product data source 106 for their contributions to that work product. By integrating this financial data with the technical data from the work product data source 106, the system 100 may perform nuanced analyses that reveal insights into cost-effectiveness and return on investment (ROI) for each worker's contributions. Such payroll data may, for example, include data representing the salaries, bonuses, and/or other forms of compensation paid to the workers. This data helps in understanding the direct financial costs associated with the production of the work product created by the workers

The financial data source 108 may include data representing additional financial benefits provided to the workers, such as health insurance, stock options, and retirement plans, which contribute to the total cost of employment. The financial data source 108 may include financial data related to specific projects or tasks that workers are involved in, which might include allocated budgets, actual spending, and financial outcomes of projects. The financial data source 108 may include performance-related financial metrics, such as data that links financial rewards to specific performance metrics or outcomes, such as bonuses based on project success or revenue generated from a product developed by the workers.

In addition to compensation-related data, the financial data source 108 may also encompass data related to the costs of hosting and maintaining software systems in cloud environments, as well as utilization metrics such as CPU and memory usage. This data may, for example, be sourced from various cloud service providers and integrated into the system 100. Including utilization metrics provides a more granular view of resource consumption, which is essential for guiding cost discussions and optimizing cloud resource allocation.

By incorporating both cost and utilization data, the system 100 may deliver comprehensive insights into the total cost of ownership (TCO) of software projects. This analysis is crucial for stakeholders as it aids in making well-informed decisions regarding resource allocation, budgeting, and the financial viability of employing cloud technologies in software development processes. Understanding the interplay between resource utilization and associated costs allows organizations to strategically manage their cloud infrastructure, ensuring that they are not only meeting their developmental needs but also doing so in a cost-effective manner.

The financial data source 108 may be implemented in any of a variety of ways. For example, at a high level, the financial data source 108 may include any kind of financial management system that aggregates and analyzes financial data across an organization. The financial data source 108 may include, for example, an Enterprise Resource Planning (ERP) systems, which integrates various functions including finance, HR, and operations, providing a holistic view of the financial data related to workers, such as SAP ERP or Oracle NetSuite.

The financial data source 108 may include a Human Resources Information System (HRIS), which is a system that manages employee data, including payroll, benefits, and compensation. Examples of HRIS systems are Workday and BambooHR. The financial data source 108 may include a payroll system, which is a dedicated system that manages the payment of wages and salaries. Examples of payroll systems include ADP and Paychex.

More specifically, the financial data source 108 may be implemented using specific tools or software solutions that handle detailed financial transactions and reporting, such as accounting software (e.g., QuickBooks or Xero) and/or project costing tools (e.g., Microsoft Project, Smartsheet).

The financial data source 108 may include or obtain data from one or more banks. This integration allows the system 100 to access real-time financial transactions, account balances, and other relevant financial information associated with the workers. By linking directly with banking institutions, the financial data source 108 can automatically pull detailed compensation data, such as salaries, bonuses, and other forms of direct monetary compensation that are processed through these banks. This direct link ensures that the data in the financial data source 108 is accurate, up-to-date, and reflective of the actual financial transactions occurring in relation to the workers.

The financial data source 108 may also include or obtain data from one or more cryptocurrency wallets. As workers may receive parts of their compensation in cryptocurrencies, or may engage in transactions relevant to their employment using digital currencies, it may be helpful for the financial data source 108 to capture this aspect of financial activity. By linking to cryptocurrency wallets, the system 100 can track and analyze transactions made in cryptocurrencies, including the receipt of digital assets as part of compensation packages or payments for specific projects or tasks.

The system 100 also includes a data sources module 110. In general, the data sources module 110 receives data from the plurality of data sources 104 (e.g., the work product data source 106 and/or the financial data source 108) (FIG. 2, operation 202) and processes such data to produce ingested data 112 as output (FIG. 2, operation 204). A variety of techniques that the data sources module 110 may use to receive data from the plurality of data sources 104 and to generate the ingested data 112 will be described below. Although the data sources module 110 may generate data based on the data received from the plurality of data sources 104, such that the ingested data 112 may include generated data which was not present in the plurality of data sources 104, the ingested data 112 may also include data which was present in the plurality of data sources 104.

The data sources module 110 may receive the data from the plurality of data sources 104 in any of a variety of ways. For example, the system 100 may execute an invitation process that is a preliminary step which facilitates the subsequent data exchange between a requester (e.g., an investor) and a target (e.g., a company in which the investor is considering investing). For example, the invitation process may begin when an investor (referred to more generally herein as a “requester”) identifies a potential investment or acquisition target. To initiate due diligence or further engagement, the requester may send an electronic invitation to the target company. This invitation may be the first step in establishing a data-sharing relationship that will allow the requester to assess the target's value accurately.

The invitation process may be implemented using various computerized methods, ensuring efficiency, traceability, and security. For example, the invitation process may include sending an invitation via email. This can be done using standard email services or through a more secure, encrypted email system if confidentiality is a concern. As another example, a specialized platform may facilitate the invitation process by providing structured workflows for sending invitations, tracking responses, and managing subsequent data exchanges. As yet another example, a custom web portal may be used to guide the requester through the necessary steps to formally issue an invitation, ensuring all required information is provided. As yet another example, one or more application program interfaces (APIs) may be used to integrate the invitation process with other business systems (e.g., CRM systems), thereby automating the invitation process based on certain triggers or business rules.

Given the potentially sensitive nature of the information exchanged following the invitation, any of a variety of security measures may be implemented to maintain the security of sensitive data. This may include, for example, using secure transmission protocols (e.g., HTTPS, SSL/TLS), data encryption, and/or digital signatures to authenticate the identity of the parties involved.

The target may accept the invitation from the requester in any of a variety of ways. For example, the target may send a confirmation email back to the requester to accept the invitation. Such an invitation may include any text which indicates acceptance of the invitation. As another example, and to ensure the authenticity and non-repudiation of the acceptance, one or more digital signatures may be used to implement the target's acceptance of the invitation, such as by the target signing a digital document that formally accepts the invitation. If the requester has a dedicated portal for managing investments or acquisitions, the target may log in to this portal and formally accept the invitation through a user interface designed for this purpose. For organizations that use enterprise resource planning (ERP) or customer relationship management (CRM) systems, the acceptance may be recorded and managed within these systems. One or more APIs may be used to automate the acceptance process, especially when integrating with other systems, such as CRM or ERP. The target may trigger an API call that records the acceptance in both the requester's and the target's systems. Secure messaging platforms that comply with industry standards may be used to send and receive acceptance notifications. Such platforms offer end-to-end encryption, ensuring that the acceptance is communicated securely.

After the target accepts the invitation from the requester, the target may select a pre-existing account of the target with the requester or create a new account. In either case, the target's account will facilitate further interactions and data exchanges between the requester and the target. This account serves as a centralized repository for information associated with the target, streamlining communication and ensuring that all necessary data is readily accessible for due diligence or other evaluative processes. The system 100 may, for example, prompt the target to create an account on the requester's platform or system, such as through a dedicated web portal, a third-party service, or directly within an enterprise system. During account creation, the target may be required to provide basic information such as company name, contact details, and other relevant organizational details. Security measures such as setting up a strong password, multi-factor authentication, and security questions may be used during this phase to protect the account.

As mentioned above, the data sources module 110 retrieves data from the plurality of data sources 104. The data sources module 110 may use any of a variety of methods to retrieve data from the plurality of data sources 104, each tailored to meet specific security and operational needs. In one such method, the data sources module 110 establishes a link to the target's data sources 104 and retrieves data from the plurality of data sources 104 via that link. The data sources module 110 may establish the link using any of a variety of techniques, such as by using OAuth or a similar technology.

This link-based approach allows the data sources module 110 to extract necessary data without requiring direct access to the target's data environment. By doing so, it ensures that the data sources module 110, as well as the requester more generally, do not interact directly with the sensitive internal systems of the target (e.g., the plurality of data sources 104). This method not only enhances the security of the data exchange by minimizing potential exposure but also maintains the integrity and confidentiality of the target's data sources. This embodiment is especially crucial in scenarios where data sensitivity and privacy are paramount, providing a secure bridge to access required data while upholding stringent security standards.

The plurality of data sources 104 may, for example, be located within one or more computer systems of the target, and the data sources module 110 may be located within one or more computer systems of the requester. The computer systems of the target and the computer systems of the requester may be physically and/or logically distinct from each other. For example, the computer systems of the target and the computer systems of the requester may be on different networks (e.g., Local Area Networks) from each other. As this implies, the plurality of data sources 104 and the data sources module 110 may be on different networks from each other.

In an alternative embodiment of the system, the data sources module 110 may use an agent-based approach, in which a specialized software agent is installed on the target's computer systems. The target may, for example, download the agent from the requester's computers and install the agent locally. The agent may be specifically designed to interact with the target's data sources 104, retrieve necessary data, and securely upload it to the data sources module 110, which in this scenario, may function as a server located outside the target's environment.

The agent may have the capability to query, collect, and process data from the plurality of data sources 104. This might involve, for example, accessing databases, file systems, and/or other data repositories. Before transmission to the data sources module 110, the agent may preprocess the data to conform to the formats and structures required by the data sources module 110. This might include data normalization, encryption, and/or compression. As another example, the agent may summarize and/or filter data from the plurality of data sources 104 and provide only the resulting summarized and/or filtered data to the data sources module 110. The agent may securely upload the processed data to the data sources module 110 using encrypted channels to ensure data integrity and confidentiality.

Both the link-based (e.g., OAuth) and agent-based approaches offer distinct methods for retrieving data from the plurality of data sources 104 and providing the retrieved data to the data sources module 110. Each has its advantages and disadvantages, depending on the specific requirements and constraints of the target's environment. For example, benefits of the link-based approach include not requiring the installation of additional software on the target's systems, reducing the complexity of setup and maintenance; easy scalability by providing the ability to handle multiple data sources and targets without significant changes to the target's infrastructure; reduced load on the targets systems; and flexibility in adding new data sources. Advantages of the agent based approach include enhanced security as a result of processing data locally within the target's environment; the ability to customize the agent to meet the unique data needs and security requirements of the target; enabling data to be retrieved offline; and providing the target with greater control over the data, which can be crucial for compliance with stringent data protection regulations. A particular benefit of the agent-based approach is that it may be used to provide to the data sources module 110 only data from the plurality of data sources 104 which are necessary for the other components of the system 100 to perform the functions described below. In this way, the benefits of the system 100 may be obtained in a way that exposes the minimal amount of data necessary from the target (e.g., the plurality of data sources 104) to the requester (e.g., the data sources module 110).

Both the link-based and agent-based embodiments provide the benefit of enabling the data sources module 110 to obtain data automatically from the plurality of data sources 104, thereby reducing or eliminating the need for the target to manually enter data into the data sources module 110.

Although the link-based and agent-based approaches are described herein as alternatives to each other, embodiments of the present invention may use both approaches in any combination.

The data sources module 110 may normalize any of the data retrieved from the plurality of data sources 104 and store the original retrieved data and/or normalized data in a data store of any suitable type. Any of the functions that are described herein as being performed on the retrieved data may be performed on the pre-normalized retrieved data and/or on the normalized retrieved data. As this implies, the ingested data 112 may include the pre-normalized retrieved data and/or the normalized retrieved data. Normalization performed by the data sources module 110 may include, for example, any one or more of the following:
Data Cleaning: Initial cleaning of data to remove duplicates, correct errors, and handle missing values.
Standardization: Converting data into a uniform format, which may involve standardizing date formats, units of measurement, or string formatting (e.g., capitalization).
Scaling: Adjusting data scales so that they are consistent across different sources. For example, converting all currency values to a single currency or normalizing financial figures to a common scale.
Encoding: Transforming categorical data into numerical formats that can be used in mathematical calculations and machine learning models.

One embodiment of the present invention relates to a computer-automated system and method for identifying copyrighted source code embedded within other source code files, utilizing advanced semantic analysis techniques. This embodiment of the invention addresses the challenge of detecting both literal and non-literal copies of copyrighted code, including instances where the code has been modified in non-semantic ways, such as through renaming variables, changing formatting, or rearranging code blocks. This embodiment creates semantic embeddings of source code using a large language model (LLM). Each segment of source code is transformed into a high-dimensional vector that captures its semantic essence, rather than its literal text. These vectors are then compared using sophisticated similarity metrics, such as cosine similarity or L2 distance, to determine the likelihood of copyright infringement. This embodiment can operate without direct access to the full source code, thereby enhancing privacy and security. Instead, the system works with embeddings that represent the semantic information of the code, significantly reducing the risk of data exposure. Additionally, this embodiment of the invention may include a compression module that further minimizes the data footprint by compressing the semantic vectors, enhancing the system's efficiency and scalability. This embodiment of the invention is particularly suited for use in environments where large volumes of code need to be analyzed quickly and accurately, such as in continuous integration/continuous deployment (CI/CD) pipelines. It provides a robust, scalable, and secure solution for managing copyright compliance in software development, offering significant improvements over traditional text-based or hash-based comparison methods.

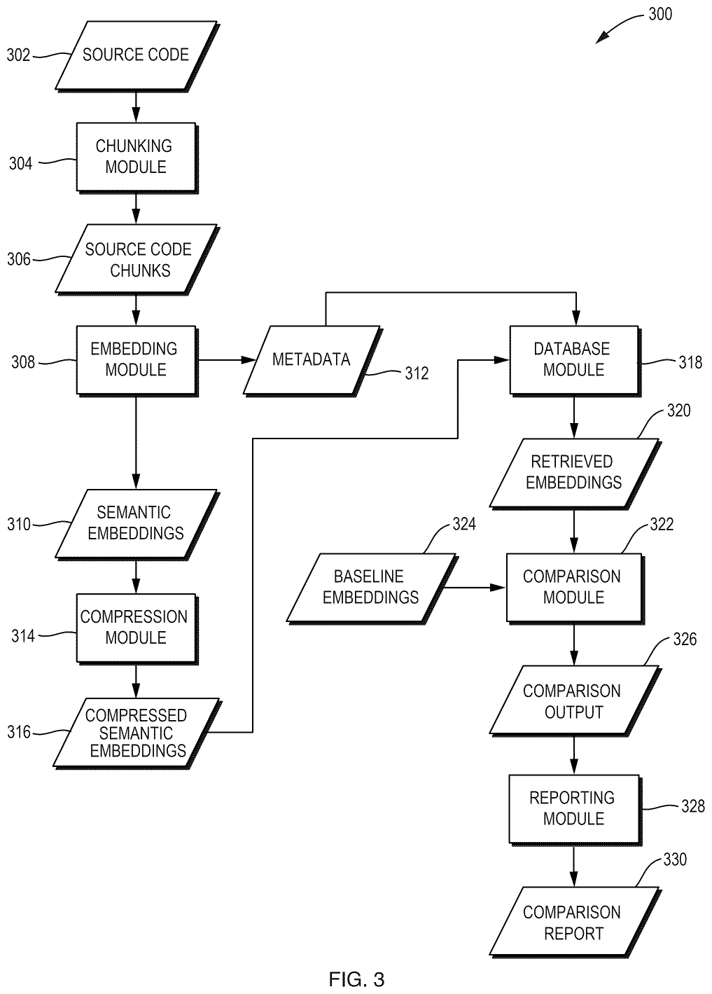

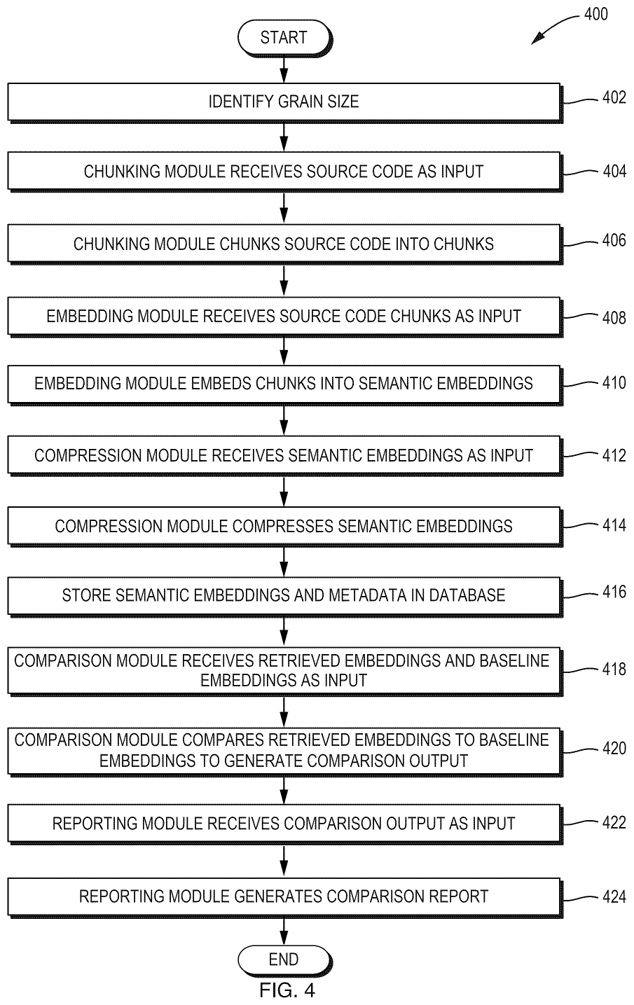

Referring to FIG. 3, a dataflow diagram is shown of a system 300 for analyzing source code to detect copyrighted code within that source code according to one embodiment of the present invention. Referring to FIG. 4, a flowchart is shown of a method 400 performed by the system 300 according to one embodiment of the present invention.

The system 300 includes subject source code 302, which may, for example, be part of the work product data source 106 as illustrated in system 100 of FIG. 1. The subject source code 302 is referred to as “subject” source code to indicate that it is the subject of the analysis performed by the system 300 and method 400. As detailed below, system 300 is designed to determine whether the subject source code 302 contains any “reference source code.” Herein, “reference source code” refers to any code that is subject to comparison against subject source code 302, including but not limited to code that is copyrighted or otherwise restricted. Reference source code may encompass source code that is not licensed for use by the owner or licensee of subject source code 302. This could include, for example, source code protected by one or more intellectual property rights such as copyright, patent, and/or trade secret, which are not owned or licensed for use by the owner or licensee of the subject source code 302. These examples are illustrative and do not limit the scope of the present invention. More broadly, reference source code includes any source code against which some or all of the subject source code 302 is intended to be compared.

The reference source code, against which the subject source code 302 is compared, may take any of a wide variety of forms. For example, the reference source code may be written in any programming language. As another example, the reference source code may be stored in any type(s) and number of files, and be stored across various storage mediums, whether they are local or distributed systems, including cloud-based repositories. This flexibility ensures that the system 300 is not limited by language syntax or storage format, allowing it to effectively analyze the subject source code 302 against any existing codebase(s). Additionally, the reference source code may include, for example, not only complete applications or systems but also snippets, libraries, frameworks, and other reusable code components that are commonly shared or reused in software development projects.

The system 300 is equipped with the capability to determine or identify the granularity of analysis to be performed on the subject source code 302 (FIG. 4, operation 402). This granularity may, for example, be defined in terms of the number of lines of code to be analyzed in each chunk of source code, also referred to herein as “grain size.” The determination of this granularity may be made through various means, including, but not limited to, receiving manual input from a human user selecting or otherwise specifying the grain size.

The granularity of analysis (e.g., grain size) influences the sensitivity and focus of the copyright or plagiarism detection process. By segmenting the source code into manageable parts, the system 300 can apply its semantic analysis more effectively, ensuring that each segment is thoroughly analyzed for potential matches with reference source code. This segmentation helps in isolating specific portions of the code, making it easier to pinpoint exact locations of potential infringements or similarities.

Configurable granularity provides the system 300 with the flexibility to adapt to various types of source code and copyright detection needs. Different projects may require different levels of scrutiny, and being able to adjust the granularity allows the system 300 to cater to a broad range of use cases, from detailed examination of small code snippets to more general analysis of large code bases. Furthermore, by adjusting the granularity, the system 300 can optimize its processing speed and resource utilization. Finer granularity might be more computationally intensive but can provide more detailed insights, whereas coarser granularity can speed up the analysis process when less detail is sufficient. This trade-off between detail and efficiency can be managed according to the user's needs. Configurable granularity also helps in balancing the breadth and depth of the analysis performed by the system 300. Finer granularity can increase the accuracy of detecting non-literal copying by focusing on smaller segments of the code, which might include subtle modifications that broader scans could overlook. This is particularly useful in complex software projects where small segments of code may carry significant intellectual property value.

The system 300 of FIG. 3 may be implemented using any of a variety of computer hardware and/or software. As merely one example, the system 300 may be implemented using a single executable software application.

The system 300 includes a chunking module 304, which receives the subject source code 302 as input (FIG. 4, operation 404), and chunks the subject source code 302 (e.g., each of a plurality of files within the subject source code 302) into source code chunks 306, each of which has a size that is equal to or approximately equal to the grain size previously identified (FIG. 4, operation 406). The chunking module 304 may ensure that each chunk is a discrete unit of code that can be independently analyzed by the subsequent stages of the system 300, particularly for detailed semantic analysis and comparison against reference source code. Each of the source code chunks 306 may be a unique unit of source code from the subject source code 302.

The chunking module 304 may ensure that the integrity and context of the subject source code 302 are preserved by the chunking process. For example, the source code chunks 306 may maintain logical groupings of source code, such as functions or classes from the subject source code 302, within individual chunks to ensure that the subsequent semantic analysis is as accurate as possible.

In some embodiments, the chunking module 304 ensures that every chunk has exactly the previously-specified grain size, which ensures uniformity in the handling of the subject source code 302, and can aid in the accuracy of matching algorithms by providing a standard basis for comparison. Furthermore, by adhering to a predetermined grain size, the system 300 can optimize its computational resources. Algorithms of the system 300 can be fine-tuned to the specific chunk size, potentially improving processing speed and reducing computational overhead.

Alternatively, the chunking module 304 may allow the source code chunks 306 to vary in their grain size, which offers several advantages. For example, different sections of source code can vary significantly in complexity and functionality. By adjusting the grain size according to the complexity of different parts of the code, the system 300 can provide a more nuanced analysis. For instance, more complex functions might require finer granularity to capture subtle nuances, while simpler, more repetitive sections might be adequately analyzed with larger chunks. As another example, variable grain sizes allow the system to maintain contextual integrity by not arbitrarily cutting off code segments. This is particularly important for maintaining logical groupings of code, such as complete functions or classes, within single chunks, which can lead to more accurate semantic analysis. As yet another example, variable grain sizes can improve the detection capabilities of the system by allowing it to focus on smaller segments where exact matches might be more likely to occur, while using broader analysis for areas less likely to contain infringements. This targeted approach can increase the overall sensitivity and specificity of the detection process.

The system 300 also includes an embedding module 308, which receives some or all of the source code chunks 306 (also referred to as “grains”) as inputs (FIG. 4, operation 408), and embeds each of the grains into a format that is amenable to advanced computational analysis (FIG. 4, operation 410). For example, the embedding module 308 may embed each of some or all of the source code chunks 306 into a corresponding array (embedding), such as by using a large language model (LLM) embedding model. This results in a plurality of semantic embeddings 310 corresponding to the plurality of source code chunks 306.

In addition to or instead of an LLM, the system 300 may use any of a variety of other techniques to analyze the semantic meaning of the source code chunks 306 effectively, and thereby generate the semantic embeddings 310 or other data structures that may be used to analyze the semantic meaning of the source code chunks 306. Such techniques include, for example:
Feature Extraction Techniques: Methods such as Term Frequency-Inverse Document Frequency (TF-IDF), n-grams, or bag-of-words models can be utilized to extract significant features from the source code chunks 306. These features may then transformed into vector representations that capture key semantic and syntactic elements of the source code chunks 306.
Syntax-Based Embeddings: By analyzing syntax trees of the source code chunks 306, the embedding module 308 may create embeddings based on the structural aspects of that code. This approach focuses on the hierarchical and logical relationships within the code, providing a different dimension of semantic analysis.
Graph-Based Models: Representing the source code as a graph where nodes correspond to code entities (such as functions and variables) and edges represent interactions (like function calls or variable references), allows the use of Graph Neural Networks (GNNs) to generate embeddings. These graph-based embeddings can capture both the flow and the architectural dependencies within the code.
Autoencoders: Autoencoders can be trained to compress source code into a dense, lower-dimensional representation that retains essential information about the code's functionality. This technique is particularly useful for reducing the dimensionality of the data while preserving its semantic integrity.

The arrays in the plurality of semantic embeddings 310 may have any number of dimensions. In practice such arrays often have 768 dimensions, although this number can vary depending on the specific requirements and configurations of the system. As other examples, the number of dimensions may be greater than 100, greater than 500, or greater than 1000. Each dimension of the array represents a feature extracted from the subject source code 302, capturing various semantic and syntactic properties of the code.

The primary purpose of embedding the source code chunks 306 into high-dimensional arrays is to capture the underlying semantics of the code, which goes beyond mere syntactic representation. This allows the system 300 to understand more about the functionality and behavior of the code, rather than just its textual appearance. By converting the source code chunks 306 into a uniform vector format, the system 300 can easily compare different pieces of code using mathematical metrics such as cosine similarity or Euclidean distance. This is valuable for identifying similarities between the analyzed code and reference source code, even if the actual text differs significantly.

High-dimensional embeddings can be processed and compared much more efficiently than raw source code text, especially when dealing with large datasets. This scalability is vital for applications in continuous integration/continuous deployment (CI/CD) environments where rapid analysis is required. Although the plurality of semantic embeddings 310 may be high-dimensional, they typically represent a reduction in dimensionality compared to the original subject source code 302 when considering the complexity and length of typical software projects. This reduction helps in abstracting essential features and ignoring irrelevant details, which enhances processing speed and reduces noise in the analysis.

Although the Roberta LLM is one LLM that may be used by the embedding module 308 to generate the plurality of semantic embeddings 310, there are several alternative methods and models that may be used for embedding the source code chunks 306 into the semantic embeddings 310. For example, besides Roberta, other LLMs like BERT, GPT, or XLNet may be employed, each offering unique strengths in terms of understanding context, handling different programming languages, or capturing long-range dependencies in code. For specific applications or proprietary programming languages, custom LLMs may be trained on domain-specific datasets to better capture the nuances and common patterns in that particular domain. Techniques such as PCA (Principal Component Analysis) or t-SNE (t-Distributed Stochastic Neighbor Embedding) may be applied after initial embedding to further reduce dimensionality and enhance the focus on features most relevant to copyright detection. By leveraging these advanced embedding techniques, the system 300 may be equipped to perform robust, efficient, and accurate analysis of source code, facilitating effective detection of potential copyright infringements or unauthorized use of reference source code.

The embedding module 308 may skip over (i.e., not embed) binary chunks in the source code chunks 306. For example, for each of the source code chunks 306, the embedding module 308 may determine whether that chunk contains binary code. If the chunk is determined to contain binary code, then the embedding module 308 may not embed that chunk. If the chunk is not determined to contain binary code, then the embedding module 308 may embed that chunk. The embedding module 308 may discern text from binary data using any of a variety of techniques, such as either or both of: (1) a byte-order mark (BOM) check; and (2) by attempting to convert the bytes in the chunk into text (e.g., using a standard Python library) and determining whether the conversion completes successfully.

Selectively skipping over (not embedding) binary chunks can have a variety of benefits. For example, binary files (such as images, executables, or libraries) generally do not contain human-readable text or source code that would be meaningful to semantic analysis models like LLMs. By skipping these binary chunks, the system 300 can save substantial computational resources. This efficiency allows the system 300 to allocate more processing power and memory to analyzing text chunks where meaningful insights can be derived. Furthermore, focusing on text chunks ensures that the embeddings created are rich in relevant information and more likely to contribute to accurate analysis outcomes, such as detecting copyright infringement. As another example, binary files may include proprietary or sensitive information that might raise security or compliance issues if mishandled. By focusing on text chunks, the system 300 can potentially avoid these risks, especially if the binary content is not essential for the analysis being performed.

The system 300 may compile or otherwise transform some or all of the subject source code 302 and/or the source code chunks 306 into code written in a lower-level language, such as LLVM Intermediate Representation (LLVM IR). Transforming the subject source code 302 into lower-level code has the benefit of abstracting away from specific language syntax and other superficial elements, thereby enabling the system 300 to focus instead on the underlying operational semantics of the subject source code 302.

The embedding module 308 may perform any of the functions disclosed herein on such lower-level code, either instead of or in addition to performing such functions on the subject source code 302 and/or the source code chunks 306. As this implies, any operations disclosed herein as being performed on or in connection with the subject source code 302 and/or the source code chunks 306 may, additionally or alternatively, be performed on or in connection with lower-level code that the system 100 derives from the subject source code 302 and/or the source code chunks 306. Any description below of transforming the subject source code 302 into lower-level code should be understood to encompass transforming some or all of the subject source code 302 and/or some or all of the source code chunks 306 into lower-level code.

For example, the system 100 may compile the subject source code 302 into code written in a lower-level language. This compilation may, for example, include translating high-level language constructs into a form that is closer to machine code, yet remains independent of machine-specific code constraints. LLVM IR is particularly suited for this purpose as it provides a low-level, yet language-agnostic, representation of the program logic.

By compiling the source code 302 to LLVM IR, the system 100 may normalize the source code 302 in a way that removes language-specific syntax and other non-semantic elements such as whitespace, comments, and compiler directives. This normalization may also effectively filter out dead and/or unused blocks of code that do not contribute to the program's runtime behavior, ensuring that the embeddings focus solely on the operational aspects of the code.

Post-compilation, the embedding module 308 may process the resulting lower-level code (e.g., LLVM IR code) in any of the ways disclosed herein to generate the plurality of semantic embeddings 310. The resulting plurality of semantic embeddings 310 capture the essential semantic features of the lower-level code.

One advantage of compiling to a lower-level format (e.g., LLVM IR) before embedding is the ability to perform semantic comparisons across different programming languages. Since LLVM IR provides a common representation, the comparison module 322 may compare source code from different languages with each other on a semantic level, thereby focusing on what the code does rather than how it is syntactically expressed.

Similarly, even for subject source code and reference source code written in the same programming language, this approach allows for deeper semantic comparisons that are not obscured by superficial code elements. It enables a more accurate detection of functional similarities and differences without being misled by non-semantic content.

The system 300 may include a compression module 314, which may receive some or all of the plurality of semantic embeddings 310 as inputs (FIG. 4, operation 412) and compress those semantic embeddings to produce compressed semantic embeddings 316 (FIG. 4, operation 414). The compression module 314 may use any of a variety of compression techniques to produce the compressed semantic embeddings 316, such as binary quantization. Performing such compression may, for example, reduce the size of the semantic embeddings 310 (“fingerprints”) to a relatively small size (e.g., 768 bits or less), which is roughly the size of a SHA 512 hash. As other examples, the compressed semantic embeddings may have a size of no more than 1024 bits, no more than 512 bits, or no more than 256 bits. The compression module 314 may perform compression without loss of semantic information. Any reference herein to the plurality of semantic embeddings 310 should be understood to be equally applicable to the compressed semantic embeddings 316 or to any combination of the plurality of semantic embeddings 310 and the compressed semantic embeddings 316. The compression module 314 and the compression that it performs is optional. As this implies, the system 300 may not include the compressed semantic embeddings 316.

The compression module 314 has a variety of advantages. For example, high-dimensional embeddings, while rich in information, can consume significant storage space. Compressing these embeddings to a smaller size drastically reduces the amount of storage needed. This is particularly advantageous in systems where large volumes of code are analyzed, leading to substantial data generation. Smaller data sizes generally translate to faster data processing. Compressed embeddings can be compared, indexed, and retrieved more quickly than their uncompressed counterparts. Despite the reduction in size, a well-designed compression algorithm, such as binary quantization, can retain the essential semantic information contained in the embeddings. This ensures that the utility of the embeddings in tasks like similarity detection or pattern recognition is not compromised.

Although binary quantization is one effective method for compressing semantic embeddings, several other techniques can also be employed depending on the specific requirements and constraints of the system such as vector quantization, dimensionality reduction, lossy compression, sparse representation, and entropy encoding. The compression module 314 may use such techniques individually or in combination in a variety of ways.

The system 300 also includes a database module 318. The system 300 provides the plurality of semantic embeddings 310 (or the compressed semantic embeddings 316), along with their metadata 312, to the database module 318, such as by transmitting such information over a network to a server that hosts the database module 318 (FIG. 4, operation 416). (Note that the embedding module 308 may extract the metadata 312 from the source code chunks 306 and/or the plurality of semantic embeddings 310.) Examples of the metadata 312 include, for each chunk, the filename of the file from which the chunk was extracted, the line number in the source file where the chunk begins, and the size of the chunk (e.g., in bytes or lines).

The database module 318 serves as a central repository for storing and managing the semantic embeddings 310, whether they are in their original form (i.e., the semantic embeddings 310) or compressed form (i.e., the compressed semantic embeddings 316), along with associated metadata 312. Associations between each of the semantic embeddings 310 and its corresponding metadata in the metadata 312 may be stored within the database module 318 in any of a variety of ways. The process of transferring the plurality of semantic embeddings 310 and metadata 312 to the database module 318 sets the stage for the subsequent analysis and retrieval processes within the system 300.

The database module 318 may, for example, be implemented using a vector database, such as pgvector. Vector databases are specialized database systems designed specifically to handle vector data, such as the plurality of semantic embeddings 310. Vector databases are optimized for storing and managing large volumes of vector data, making them ideal for the plurality of semantic embeddings 310. For example, one of the primary functions of semantic embeddings is to enable similarity searches, where the system identifies embeddings that are close or similar to each other based on their vector distances. Vector databases like pgvector are specifically designed to support these types of queries efficiently, using indexing strategies that are optimized for high-dimensional data spaces.

The database module 318 may reside on or otherwise be hosted by a server, which may be located on-premises or hosted remotely in a cloud environment. The semantic embeddings 310 and their corresponding metadata 312 may be transmitted to the database module 318 over a network, ensuring centralized storage and accessibility.

Although the database module 318 is shown and referred to herein as a “database” module, the database module 318 may more generally be implemented using any one or more data stores which are capable of performing the functions disclosed herein, whether or not such data stores take the form of a database. Furthermore, while transmitting data over a network to a server-hosted database is common, the database module 318 may be implemented locally, thereby eliminating the need for network transmission.

The system 300 includes a comparison module 322, which retrieves semantic embeddings (referred to as “retrieved embeddings 320”) stored in the database module 318 (FIG. 4, operation 418) and compares them to baseline embeddings 324 which were previously generated based on reference source code. Reference source code may include any source code which serves as a standard or benchmark for comparison, such as copyrighted source code from repositories such as GitHub or GitLab. The system 300 may generate the baseline embeddings 324 at any time, in any of the ways disclosed herein for generating the semantic embeddings 310.

The comparison module 322 retrieves the semantic embeddings (retrieved embeddings 320) from the vector database within the database module 318. These embeddings represent the semantic essence of the source code chunks analyzed by the system 300. The comparison module 322 compares the retrieved embeddings 320 to the baseline embeddings 324. The comparison may be conducted using various techniques, such as cosine similarity, although other techniques, such as L2 distance, Euclidean distance, or Manhattan distance may be used. The comparison module 322 generates, based on the results of these comparisons, comparison output 326 (FIG. 4, operation 420). The comparison output 326 can be used to identify potential instances of code reuse, plagiarism, or unauthorized copying.

The comparison module 322 may normalize both the retrieved embeddings 320 and the baseline embeddings 324 to ensure that they are on a comparable scale. The comparison module 322 may align corresponding embeddings within the retrieved embeddings 320 and the baseline embeddings 324, such as by using metadata associated with the retrieved embeddings 320 and/or the baseline embeddings 324. For each pair of corresponding (e.g., aligned) embeddings in the retrieved embeddings 320 and the baseline embeddings 324, the comparison module 322 may compute a similarity (e.g., distance metric) for that pair of embeddings. The result may, for example, be a score (e.g., distance) that quantifies the similarity or dissimilarity between the two embeddings in the pair.

The comparison module 322 may, for example, use a threshold for similarity (e.g., distance) scores, which determines what level of similarity between two embeddings is considered to be significant. The comparison module 322 may identify all pairs of embeddings for which the similarity score satisfies the threshold (e.g., exceeds or falls below the threshold, depending on how the similarity score is defined). Identified pairs of embeddings may correspond to potential instances of code reuse, plagiarism, or unauthorized copying.

The comparison output 326 generated by the comparison module 322 may be structured, represented, and presented in any of a variety of ways, depending on the specific needs of the users and the intended use of the data. For example, the comparison output 326 may include detailed pairwise comparison results between pairs of corresponding embeddings in the retrieved embeddings 320 and the baseline embeddings 324. This is the simplest and most straightforward form of the comparison output 326, in which the comparison output 326 includes results of each individual pairwise comparison. In this case, the comparison output 326 may include, for example, information about each pair of compared embeddings (e.g., the text of the source code corresponding to those embeddings), the corresponding comparison result (e.g., similarity score), and metadata for the embeddings in the pair, such as file names and line numbers. This format is particularly useful for detailed audits and code reviews where every potential match needs to be examined.

As another example, the comparison output 326 may include an aggregate summary of any of a variety of forms. For example, the comparison module 322 may aggregate pairwise comparison results into the comparison output 326 to provide statistical summaries, such as the average, median, or distribution of pairwise similarity scores. This summary may help in quickly assessing the overall similarity between the subject source code 302 and the reference code. Another aggregate form that may be stored in the comparison output 326 is the number of matches that exceed the predefined similarity threshold, providing a quick overview of potential issues without detailing every match.

As yet another example, the comparison output 326 may include data which categorizes comparison results based on the severity of the matches, which may be inferred, for example, from the pairwise similarity scores produced by the comparison module 322. For example, matches may be categorized into “high,” “medium,” and “low” concern levels. Another example of a categorization that may be represented in the comparison output 326 is a categorization by sections of the subject source code 302 and/or reference code, such as modules or functions, summarizing how many and which types of matches were found in each section.

In addition to retrieving and comparing the retrieved semantic embeddings 320 to the baseline embeddings 324, the comparison module 322 may retrieve and leverage the metadata 312 to improve the accuracy and relevance of the comparison process. The retrieved metadata, which may include information such as the origin file, line numbers, and/or chunk size of the source code/source code chunks corresponding to the retrieved embeddings 320, may perform one or more of the following functions in the comparisons performed by the comparison module 322:
Alignment of Code Segments: The comparison module 322 may use retrieved metadata to assist in accurately aligning the subject source code chunks (or their corresponding retrieved semantic embeddings 320) with the appropriate segments of the reference source code (or their corresponding baseline embeddings 324). By using file names and line numbers, for example, the comparison module 322 may ensure that comparisons are made between corresponding parts of the code, thereby enhancing the validity of the comparison results.
Focused Comparisons: The comparison module 322 may use retrieved metadata to focus the comparison on specific areas of the code that are more likely to contain similarities or are of particular interest. For example, if certain files are known to contain critical or sensitive functionality, the comparison module 322 may prioritize these files in the comparison process.
Granularity Control: Retrieved metadata representing the size of the chunks (e.g., in bytes or lines) allows the comparison module 322 to adjust the granularity of the comparisons performed. For example, the comparison module 322 may compare smaller chunks more rigorously, but subject larger chunks to a more general analysis.
Efficiency Enhancements: The comparison module 322 may use retrieved metadata to enhance the efficiency of the comparison process. For instance, if the retrieved metadata indicates that a chunk of code has not changed since the last time the comparison module 322 performed a comparison, and the previous comparison did not reveal any issues, then the comparison module 322 might skip that chunk or subject it to a less intensive re-analysis.

As the above examples illustrate, by making use of the metadata 312, as retrieved from the database module 318, in these ways, the comparison module 322 may enhance both the precision and efficiency of the comparison process, leading to more reliable and actionable outcomes.

The system 300 also includes a reporting module 328, which receives the comparison output 326 as input (FIG. 4, operation 422) and generates a comparison report 330 as output based on the comparison output 326 (FIG. 4, operation 424). The comparison report 330 may be output to a user (e.g., visually), and may take any of a variety of suitable forms to convey the contents of the comparison output 326. The comparison report 330 is intended to provide actionable insights and detailed information about the similarities detected during the comparison process. The reporting module 328 may flag any matches in the comparison output 326 that exceed a predetermined similarity threshold (e.g., a cosine similarity greater than a predetermined likeness threshold) in order to point out potential cases of copyright infringement or plagiarism to the user.

In fact, the reporting module 328 may only include output corresponding to matches in the comparison output 326 that exceed the predetermined similarity threshold in the comparison report 330, such that the comparison report 330 does not include output corresponding to matches in the comparison output 326 that do not exceed the predetermined similarity threshold. This makes it easier for the user to quickly and easily identify matches which might indicate copyright infringement or plagiarism, and which therefore merit further attention.

The comparison report 330 may, for example, incorporate interactive dashboards that allow users to explore the comparison results through visual data representations like graphs, heat maps, or network diagrams. Such user interface elements enhance user engagement and makes it easier to identify patterns and trends at a glance. The comparison report 330 may also provide options for users to generate detailed reports that delve into specific aspects of the comparison, such as particular files, modules, or time periods. The reporting module 328 may generate reports that not only cover current findings but also provide historical data comparisons to track changes and trends over time.

For an investor evaluating a potential investment in a target company, the comparison report 330 generated by system 300 offers several significant benefits. These benefits are crucial for making informed investment decisions, particularly when the quality, originality, and compliance of the software developed by the target company are key factors in the investment evaluation process. For example, the comparison report 330 can reveal how much of the target company's code is original versus how much might be derived or potentially copied from existing sources. This is crucial for assessing the value of the company's intellectual property, and enables investors to gauge the risk of intellectual property disputes or copyright infringement issues, which could affect the company's financial health and market reputation. As another example, the comparison report 330 can highlight areas where the codebase may rely heavily on outdated or problematic code, suggesting areas of potential technical debt. This can enable investors to better understand the potential costs and resources needed for future code maintenance or overhaul, which can influence the valuation of the company.

The system 300 may be used within Continuous Integration/Continuous Deployment (CI/CD) environments to enhance code compliance and integrity. CI/CD is a method of frequently integrating and deploying code changes through automated processes, which helps in maintaining software quality and accelerating the development cycle.

More specifically, the system 300 may be integrated into the CI/CD pipelines to automatically analyze code as it is committed and pushed through the development pipeline. This integration allows the system to continuously monitor and analyze new code or changes to existing code. The primary goal in this situation is to ensure that all code integrated into the product meets certain standards of compliance and originality before it is deployed. By comparing newly committed code against baseline embeddings (which include copyrighted or standard reference code), the system 300 can detect similarities that may indicate the use of copyrighted material. If the system 300 detects a high degree of similarity exceeding a predefined threshold, it can flag this for review or automatically reject the commit, preventing the potentially infringing code from being merged into the main codebase.

Such features are particularly useful in connection with automated code generation. Tools like GitHub Copilot and others assist developers by suggesting or generating code snippets based on the context provided by existing code. While these tools can significantly boost productivity, they also pose a risk of inadvertently generating code that is too similar to copyrighted material, especially since these tools learn from vast corpora of existing code, some of which may be copyrighted. By using system 300, companies can mitigate the risk of legal complications arising from the use of such tools. The system 300 can be used to ensure that any code, whether written by humans or suggested by Al tools, does not violate copyright laws before it is deployed.

To enhance the robustness and adaptability of the system 300, embodiments of the invention may incorporate the use of harmonic embeddings. Harmonic embeddings involve a method where an existing set of embeddings, generated from source code or other textual data, can be effectively adapted to a new embedding space introduced by an updated encoder model. This technique is particularly advantageous when direct access to the original data is restricted or impossible.

The process may involve using a transformation function that harmonizes the old embeddings with the new encoder, allowing them to be represented effectively in the updated vector space without the need to directly re-embed the original data. This ensures that the system can benefit from advancements in encoding technologies and improved model architectures, thereby enhancing the accuracy and relevance of the semantic comparisons, without compromising the integrity or availability of the original embeddings.

Harmonic embeddings are especially relevant in maintaining the continuity and consistency of the system 300's operations when transitioning between different embedding models. This capability ensures that the system 300 remains up-to-date with the latest technological advancements in natural language processing and machine learning, while still preserving the utility and value of previously generated data.

Embodiments of the present invention may create, store, and compare embeddings rather than directly comparing source code. For example, the comparison module 322 may compare the retrieved embeddings 320 to the baseline embeddings 324, without also comparing (or even accessing) the subject source code 302 from which the retrieved embeddings were generated or the reference source code from which the baseline embeddings 324 were generated. This approach not only enhances the efficiency and effectiveness of detecting copyright infringement and plagiarism, but also crucially respects the sensitive and confidential nature of the source code being analyzed. More specifically, embodiments of the invention transform source code into high-dimensional vector embeddings using a large language model (LLM). These embeddings capture the semantic essence of the code without retaining its exact textual form. By converting source code into abstract embeddings, the actual content of the source code is not exposed or stored directly. This abstraction layer helps protect the confidentiality of the source code. Similarly, since embeddings are high-level representations and do not contain direct code snippets, they inherently reduce the risk of sensitive code leakage.

Preserving the confidentiality of source code can be particularly valuable during the due diligence process, such as when an investor is evaluating a company that has developed proprietary software. This approach not only protects the intellectual property of the company being assessed but also ensures that the due diligence process itself adheres to high standards of data security and ethical business practices. By maintaining the confidentiality of the source code, the due diligence process protects the target company's intellectual assets from potential leaks or unauthorized access. This is crucial for software that includes innovative algorithms, business logic, or that serves as a competitive advantage. Due diligence often involves NDAs to protect sensitive information. Preserving the confidentiality of source code ensures compliance with these legal agreements, reducing the risk of legal repercussions. Investors can use embodiments of the invention to gain a deeper understanding of the technological value and potential risks associated with the target company's software assets without compromising the security or proprietary nature of the code. This informed perspective supports better strategic decision-making regarding the investment.

Because embodiments of the invention compare embeddings to each other (e.g., the retrieved embeddings 320 and the baseline embeddings 324), such comparisons may detect non-literal copying of source code. This feature is particularly valuable in contexts such as due diligence performed by an investor on a target software development company, where understanding the uniqueness and integrity of the software code is crucial. As previously described, embodiments of the may transform source code into high-dimensional vector embeddings that capture the semantic essence of the code. This transformation abstracts the code's meaning from its literal representation. Because the embeddings represent semantic content, modifications to the code that do not change its meaning (such as renaming variables, changing whitespace, or altering comments and formatting) do not significantly alter the embeddings. This allows embodiments of the invention to recognize the underlying semantic similarities despite superficial changes.

In comparison, traditional methods of code comparison often rely on textual analysis, which can miss instances where the code has been altered superficially but still retains the original's functionality or intent. By focusing on semantic similarities, embodiments of the invention can detect cases of non-literal copying-where the code's structure or syntax might have been changed but the functional essence remains the same. This includes scenarios where code has been refactored, optimized, or translated into another programming language but still performs the same operations.

As a result, investors can use embodiments of the present invention to perform a more comprehensive analysis of the target company's codebase, ensuring that not only direct copies but also subtly altered copies are identified. This thoroughness is crucial for assessing the true originality and value of the software assets. Detecting non-literal copying helps ensure that the software does not infringe on existing copyrights, which is a significant legal risk in software development. This is particularly important when the software uses open-source components that might have strict licensing conditions. By identifying potential issues of non-literal copying, investors can better manage the risks associated with intellectual property disputes, which can be costly and damaging to the company's reputation. In summary, the ability of embodiments of the invention to compare semantic embeddings rather than direct code text allows for a nuanced, in-depth analysis of code originality and integrity. This capability is particularly valuable during due diligence processes, where investors need to ascertain the legal standing, compliance, and intrinsic value of the software developed by a target company.

One advantage of embodiments of the present invention is that they store data (e.g., the plurality of semantic embeddings 310 and the baseline embeddings 324) in a highly space-efficient manner. For example, the system 300 may apply compression techniques, thereby reducing each embedding to a more manageable size, such as 768 bits, roughly the size of a SHA-512 hash. This compression significantly reduces the storage footprint without losing critical semantic information. As another example, the system 300 may utilize specialized vector databases (e.g., pgvector) that are optimized for storing and querying high-dimensional data efficiently. These databases can handle the storage and retrieval of compressed embeddings effectively, enhancing both space efficiency and query performance. By compressing the embeddings and reducing their size, the system 300 not only minimizes the amount of storage required, but can also improve the speed of data access and retrieval. Compressed embeddings can be processed, compared, and indexed more quickly, enhancing the overall performance of the system 300. Testing has demonstrated that embodiments of the invention can be 10,000 more space-efficient than competing algorithms.

Embodiments of the present invention may use indexed, semantic vectors to significantly enhance the efficiency and accuracy of searching and comparing source code. As described above, the plurality of semantic embeddings 310 created from the subject source code 302 may be stored in a vector database that uses indexing techniques optimized for high-dimensional data. Indexing these vectors allows for rapid retrieval and comparison, significantly speeding up the search process compared to non-indexed data. Furthermore, indexed searches scale efficiently with the size of the dataset. As more source code is added and more embeddings are created, the system 300 can maintain its performance due to the efficient indexing strategies.

Furthermore, because the vectors represent the semantic meaning of the subject source code 302 rather than its literal text, changes to the subject source code 302 that do not affect its functionality, such as renaming variables, modifying whitespace (in languages where whitespace is not syntactically significant), or changing comments, do not alter the semantic vectors significantly. This allows the system 300 to recognize code that performs the same function but is written differently. In languages like Python, where whitespace is significant to the structure of the code, the system 300's semantic analysis is designed to consider these aspects when creating embeddings. This ensures that the embeddings accurately reflect the code's meaning, even in languages with unique syntactic rules.

In some embodiments, the techniques described herein relate to a method performed by at least one computer processor executing computer program instructions stored on at least one non-transitory computer-readable medium, the method including: (A) chunking subject source code into a plurality of source code chunks; (B) generating, for each of the plurality of source code chunks, a corresponding plurality of semantic embeddings, thereby generating a plurality of generated semantic embeddings, wherein each of the plurality of generated semantic embeddings corresponds to a corresponding segment of source code in the plurality of source code chunks; (C) retrieving a plurality of baseline semantic embeddings from a database, wherein the plurality of baseline semantic embeddings correspond to a plurality of previously analyzed segments of reference source code; (D) comparing the plurality of generated semantic embeddings with the plurality of baseline semantic embeddings to generate comparison output.

Chunking the subject source code into the plurality of source code chunks may include chunking the subject source code into the plurality of source code chunks based on a predetermined grain size. Each of the plurality of source code chunks may have a size that is equal to the predetermined grain size.

Operation (B) may include using a large language model (LLM) embedding model to generating the plurality of generated semantic embeddings. Each of some or all of the plurality of generated semantic embeddings may have at least 100 dimensions. For example, each of some or all of the generated semantic embeddings may have 768 dimensions.

Operation (B) may include not generating semantic embeddings for binary code in the plurality of source code chunks.

Operation (B) may further include compressing the plurality of generated semantic embeddings.

The method may further include extracting metadata from the plurality of source code chunks, and operation (D) may include using the metadata to assist in comparing the plurality of generated semantic embeddings with the plurality of baseline semantic embeddings.

The method may further include extracting metadata from the plurality of generated semantic embeddings, and operation (D) may include using the metadata to assist in comparing the plurality of generated semantic embeddings with the plurality of baseline semantic embeddings.

Operation (D) may include measuring distances between the plurality of generated semantic embeddings and the plurality of baseline semantic embeddings; and generating the comparison output based on the distances.

The comparison output may include the distances.

Generating the comparison output based on the distances may include computing a metric based on the distances; and including the metric in the comparison output.

In some embodiments, the techniques described herein relate to a system including at least one non-transitory computer-readable medium having computer program instructions stored thereon, the computer program instructions being executable by at least one computer processor to perform a method, the method including: (A) chunking subject source code into a plurality of source code chunks; (B) generating, for each of the plurality of source code chunks, a corresponding plurality of semantic embeddings, thereby generating a plurality of generated semantic embeddings, wherein each of the plurality of generated semantic embeddings corresponds to a corresponding segment of source code in the plurality of source code chunks; (C) retrieving a plurality of baseline semantic embeddings from a database, wherein the plurality of baseline semantic embeddings correspond to a plurality of previously analyzed segments of reference source code; (D) comparing the plurality of generated semantic embeddings with the plurality of baseline semantic embeddings to generate comparison output.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention which perform fingerprinting cannot be performed mentally or manually by a human. For example, such embodiments include the generation and manipulation of high-dimensional vector embeddings from source code, which are used to capture the semantic essence of the code. This process involves complex mathematical computations and transformations that are only feasible with the computational power of modern processors. Additionally, the embeddings are stored in a vector database that utilizes specialized indexing techniques to facilitate efficient and scalable searches. These operations require significant processing power and memory management capabilities that exceed human cognitive abilities and manual processing methods. Furthermore, the comparison of these semantic embeddings using metrics such as cosine similarity involves calculating distances or angles between high-dimensional vectors. This task not only demands computational accuracy but also the ability to handle large volumes of data at high speeds, which can only be achieved through automated systems designed for such purposes.

Embodiments of the present invention significantly enhance the functionality of computer systems within the software development industry by specifically addressing the challenge of detecting source code plagiarism and copyright infringement. Traditional methods for detecting such infringement often rely on direct text comparison or hash-based techniques, which are not only limited in scope but also inefficient in handling complex variations in code. Embodiments of the present invention address the limitations of the prior art by employing advanced semantic analysis techniques, thereby substantially improving the computer's ability to process and analyze source code in ways that were previously unattainable with conventional methods.

For example, embodiments of the present invention may utilize semantic embeddings to represent the semantic meaning of source code in ways that are computer-processable. Unlike traditional text-based comparisons that fail to capture deeper, non-literal similarities, semantic embeddings distill the essence of the code's functionality, irrespective of superficial changes like variable renaming or reformatting. This representation may then be analyzed by a computer using sophisticated comparison metrics, such as cosine similarity, L2 distance, and others, which are capable of detecting semantic parallels between different segments of code. These metrics provide a nuanced, accurate assessment of similarity, far beyond the capabilities of traditional methods.

This approach not only enhances the detection capabilities of software systems but also contributes to a more robust and efficient processing framework. By transforming source code into high-dimensional vectors and employing advanced mathematical models for comparison, embodiments of the present invention achieve a higher level of precision in identifying potential infringements, thereby directly improving the functional capabilities of the computer systems involved in compliance monitoring.

Embodiments of the present invention also tackle a significant technical problem inherent in the field of software development: the challenge of detecting non-literal copying of source code. Traditional methods, such as direct text comparison or hash-based techniques, are primarily effective only in identifying exact or near-exact textual matches. They significantly underperform when it comes to detecting instances where the source code has been altered in ways that do not change its underlying functionality, such as through variable renaming, changes in code formatting, or even more sophisticated alterations like code refactoring. These modifications often evade detection by conventional methods, posing a substantial barrier to effective copyright enforcement and compliance within software development.

To address this challenge, embodiments of the present invention introduce a novel approach by utilizing high-dimensional vector embeddings of source code. This method transcends the limitations of traditional text-based analyses by focusing on the semantic essence of the code rather than its literal textual representation. By transforming source code into semantic embeddings, such as by using a large language model (LLM), embodiments of the present invention capture deep semantic information that reflects the functional behavior of the code segments.

These embeddings may then be compared using similarity metrics, such as cosine similarity, L2 distance, and others, which are adept at identifying semantic correlations between different pieces of code. This capability allows embodiments of the present invention to detect non-literal copying of source code effectively, even if the visible text of the code has been significantly altered. The approach not only solves the problem of identifying disguised similarities in code but does so in a manner that is computationally efficient and scalable, suitable for integration into continuous integration/continuous deployment (CI/CD) pipelines and other automated software development processes.

In conclusion, embodiments of the present invention provide a concrete technical solution to a well-defined technical problem in software development. By leveraging sophisticated semantic analysis techniques, embodiments of the present invention enhance the ability of computer systems to perform a critical function—ensuring the integrity and originality of code in a landscape where digital information is easily modified and replicated. This not only addresses a gap left by existing technologies but also advances the field of software development towards more secure and compliant practices.

Furthermore, embodiments of the present invention transforms the input data, which is source code, into a new and functionally distinct form—semantic embeddings. This transformation is not merely a reformatting of data but a substantive conversion that encapsulates the semantic essence of the source code in a high-dimensional vector space. This new form of data is then utilized in a substantially different manner, specifically for the advanced detection of copyright infringement, which traditional methods struggle to identify effectively when using only the original source code as an input.

These semantic embeddings are used in a comparison process where they are matched against a database of baseline embeddings derived from reference source code. The comparison may use metrics such as cosine similarity or Euclidean distance to identify semantic similarities and differences. This step leverages the transformed data (embeddings) to perform a function—copyright detection—that is fundamentally different from the function of the original data (source code).

The transformation of source code into semantic embeddings and their subsequent use in detecting copyright infringement exemplifies how embodiments of the invention manipulate data to achieve a useful, concrete, and tangible result. This transformation goes beyond mere data processing; it involves a redefinition of the data's purpose and utility. This not only underscores the technical nature of embodiments of the present invention, but also highlights the practical application of embodiments of the present invention in addressing a significant challenge in the field of software development.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method performed by at least one computer processor executing computer program instructions stored on at least one non-transitory computer-readable medium, the method comprising:
(A) chunking subject source code into a plurality of source code chunks;
(B) generating, for each of the plurality of source code chunks, a corresponding plurality of semantic embeddings, thereby generating a plurality of generated semantic embeddings, wherein each of the plurality of generated semantic embeddings corresponds to a corresponding segment of source code in the plurality of source code chunks;
(C) retrieving a plurality of baseline semantic embeddings from a database, wherein the plurality of baseline semantic embeddings correspond to a plurality of previously analyzed segments of reference source code;
(D) comparing the plurality of generated semantic embeddings with the plurality of baseline semantic embeddings to generate comparison output.

2. The method of claim 1, wherein chunking the subject source code into the plurality of source code chunks comprises chunking the subject source code into the plurality of source code chunks based on a predetermined grain size.

3. The method of claim 2, wherein each of the plurality of source code chunks has a size that is equal to the predetermined grain size.

4. The method of claim 1, wherein (B) comprises using a large language model (LLM) embedding model to generating the plurality of generated semantic embeddings.

5. The method of claim 1, wherein each of the plurality of generated semantic embeddings has at least 100 dimensions.

6. The method of claim 5, wherein each of the plurality of generated semantic embeddings has 768 dimensions.

7. The method of claim 1, wherein (B) comprises not generating semantic embeddings for binary code in the plurality of source code chunks.

8. The method of claim 1, wherein (B) further comprises compressing the plurality of generated semantic embeddings.

9. The method of claim 1, further comprising:
extracting metadata from the plurality of source code chunks, and
wherein (D) comprises using the metadata to assist in comparing the plurality of generated semantic embeddings with the plurality of baseline semantic embeddings.

10. The method of claim 1, further comprising:
extracting metadata from the plurality of generated semantic embeddings, and
wherein (D) comprises using the metadata to assist in comparing the plurality of generated semantic embeddings with the plurality of baseline semantic embeddings.

11. The method of claim 1, wherein (D) comprises:
measuring distances between the plurality of generated semantic embeddings and the plurality of baseline semantic embeddings; and
generating the comparison output based on the distances.

12. The method of claim 11, wherein the comparison output includes the distances.

13. The method of claim 11, wherein generating the comparison output based on the distances comprises:
computing a metric based on the distances; and
including the metric in the comparison output.

14. A system comprising at least one non-transitory computer-readable medium having computer program instructions stored thereon, the computer program instructions being executable by at least one computer processor to perform a method, the method comprising:
(A) chunking subject source code into a plurality of source code chunks;
(B) generating, for each of the plurality of source code chunks, a corresponding plurality of semantic embeddings, thereby generating a plurality of generated semantic embeddings, wherein each of the plurality of generated semantic embeddings corresponds to a corresponding segment of source code in the plurality of source code chunks;
(C) retrieving a plurality of baseline semantic embeddings from a database, wherein the plurality of baseline semantic embeddings correspond to a plurality of previously analyzed segments of reference source code;
(D) comparing the plurality of generated semantic embeddings with the plurality of baseline semantic embeddings to generate comparison output.

15. The method of claim 14, wherein chunking the subject source code into the plurality of source code chunks comprises chunking the subject source code into the plurality of source code chunks based on a predetermined grain size.

16. The method of claim 14, wherein (B) comprises using a large language model (LLM) embedding model to generating the plurality of generated semantic embeddings.

17. The method of claim 14, wherein each of the plurality of generated semantic embeddings has at least 100 dimensions.

18. The method of claim 14, wherein (B) comprises not generating semantic embeddings for binary code in the plurality of source code chunks.

19. The method of claim 14, further comprising:
extracting metadata from the plurality of source code chunks, and
wherein (D) comprises using the metadata to assist in comparing the plurality of generated semantic embeddings with the plurality of baseline semantic embeddings.

20. The method of claim 14, further comprising:
extracting metadata from the plurality of generated semantic embeddings, and
wherein (D) comprises using the metadata to assist in comparing the plurality of generated semantic embeddings with the plurality of baseline semantic embeddings.
